(19) United States
(12) Patent Application Publication
(10) Pub. No.: US 2016/0053802 A1
(43) Pub. Date: Feb. 25, 2016

(54) SUCKING DISC STRUCTURE AND PAD THEREOF

(71) Applicant: SAN HAO RUBBER COMPANY LTD., TAICHUNG CITY (TW)

(72) Inventor: HUAN WANG, TAICHUNG CITY (TW)

(21) Appl. No.: 14/464,801

(22) Filed: Aug. 21, 2014

(51) Int. Cl. F16B 47/00; F16M 13/02

(52) U.S. Cl. CPC F16B 47/00; F16M 13/02

(57) ABSTRACT

A pad of a sucking disc structure includes a main body made of a soft material, and the main body has an axial surface provided for a pressing member of a sucking disc to press, and a circular pressure bearing block integrally formed with the main body. The pressure bearing block is made of a uniform hard material, so that the axial surface defines a circular hard pressed area. When the pressing member of the sucking disc presses at the hard pressed area, the pressing forces are distributed uniformly to improve the airtightness of the sucking disc.

### FIELD OF THE INVENTION

The present invention relates to a sucking disc structure, in particular to a pad of a sucking disc structure.

### BACKGROUND OF THE INVENTION

In general, a conventional sucking disc structure has a soft pad made of rubber, and the center of the pad has a lifting portion, and the top of the pad has a pressing member. When the sucking disc is used, the pad is attached onto a smooth surface, and a control member is provided for controlling the pressing member to press at the pad, while the lifting portion is lifted upwardly to the center position of the pad. Now, the pad is pressed into an airtight status, so that the pad is lifted and deformed to form a vacuum space, so as to produce a strong suction to fix the sucking disc onto a wall.

However, if air enters into the aforementioned vacuum space, the suction will disappear since the vacuum condition is destroyed, and the sucking disc no longer has the effect of being fixed onto the smooth surface. Therefore, the pressing capability of the pressing member of the sucking disc is very important. However, the pad 6 is made of a soft material having the capability of being elastically deformed, so that when the pressing member 7 is controlled to press onto the pad 6 as shown in FIG. 7, the pressing force is absorbed by the pad 6 and weakened. On the other hand, the pressing member 7 is generally a thin casing that presses onto the pad 6 at points with a small contact area, and the position of the pad 6 being pressed is lifted to produce a deformation towards the central direction, so that the airtightness is reduced. In addition, the error of the precision of the dimensions of the components of the product makes it difficult for the pressing member 7 to apply a pressing force uniformly onto the pad 6, so that the airtightness at the position with weaker pressure is relatively lower, and external air may enter into the vacuum space to destroy the vacuum condition easily, and the time for the sucking disc to be attached onto the smooth surface becomes shorter.

In view of the aforementioned problems, it is a main subject for the present invention to provide a sucking disc structure and a pad thereof to overcome the problems of the prior art.

### SUMMARY OF THE INVENTION

Therefore, it is a primary objective of the present invention to provide a pad of a sucking disc structure having a circular hard structure integrally formed with the sucking disc structure and provided for pressing a pressing member of a sucking disc securely and allowing the pressing forces to act uniformly onto the whole circular hard structure, so as to improve the airtight effect.

To achieve the aforementioned objective, the present invention provides a pad of a sucking disc structure comprising: a main body, made of a soft material, and having an axial surface provided for a pressing member of a sucking disc to press thereon, and a circular pressure bearing block disposed on the main body, wherein the pressure bearing block and the main body are fixed and coupled to each other, and the pressure bearing block is made of a uniform hard material, and the axial surface defines a circular hard pressed area, and the main body has a lifting portion disposed in an inner portion of a ring formed by the pressure bearing block.

In an embodiment, the pressure bearing block is disposed on the axial surface.

In another embodiment, the pressure bearing block is disposed in the main body.

The present invention further provides a sucking disc structure comprising a pad, a pressing member and a control member, characterized in that the pad includes a main body made of a soft material, and the main body includes an axial surface provided for the pressing member to press thereon; the main body includes a circular pressure bearing block fixed and coupled to the main body, and the pressure bearing block is made of a uniform hard material, and the axial surface defines a circular hard pressed area; the main body includes a lifting portion disposed in an inner portion of a ring formed by the pressure bearing block; the pressing member is disposed on the axial surface, and the control member is installed on the pressing member and coupled to the lifting portion; and the pressing member includes a circular pressing portion, and the control member may control the pressing portion to move towards the pad and press onto the hard pressed area of the axial surface, while pulling the lifting portion, so that the main body produces a deformation in the inner portion of the ring formed by the pressure bearing block.

Wherein, the pressing member includes a through hole, and the lifting portion is erected from the main body and passed out from the through hole, and a threaded section is disposed around the lifting portion; the control member is blocked by a periphery of the through hole of the pressing member, and the control member includes a screw hole screwed and coupled to the threaded section of the lifting portion, such that the control member may be rotated to control the pressing member and the lifting portion to operate.

### BRIEF DESCRIPTION OF THE DRAWINGS

FIG. 1 is a perspective view of a first preferred embodiment of the present invention;

FIG. 2 is a cross-sectional view of the first preferred embodiment of the present invention;

FIG. 3 is a cross-sectional view of a second preferred embodiment of the present invention;

FIG. 4 is an exploded view of a sucking disc structure of the present invention;

FIGS. 5 and 6 are cross-sectional views showing a using status of a sucking disc structure of the present invention; and

FIG. 7 is a cross-sectional view of a conventional sucking disc structure.

### DESCRIPTION OF THE PREFERRED EMBODIMENTS

The present invention will become clearer in light of the following detailed description of an illustrative embodiment of this invention described in connection with the drawings. It is intended that the embodiments and drawings disclosed herein are to be considered illustrative rather than restrictive.

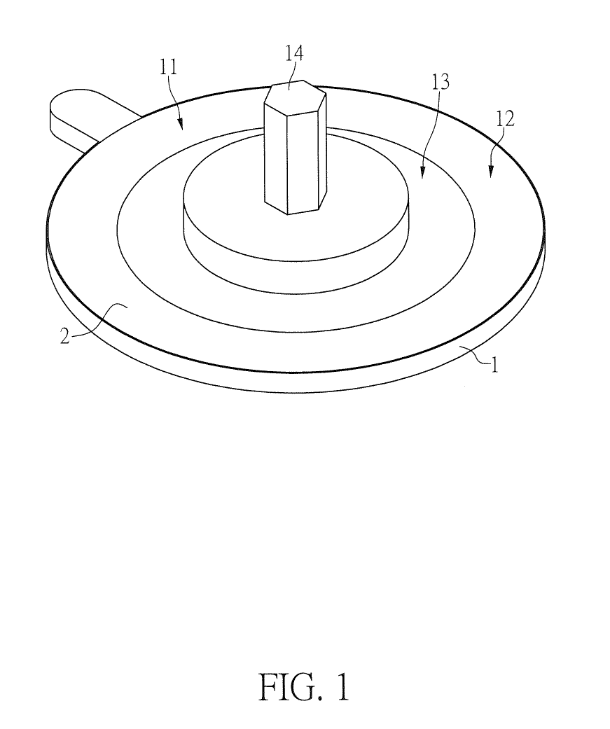

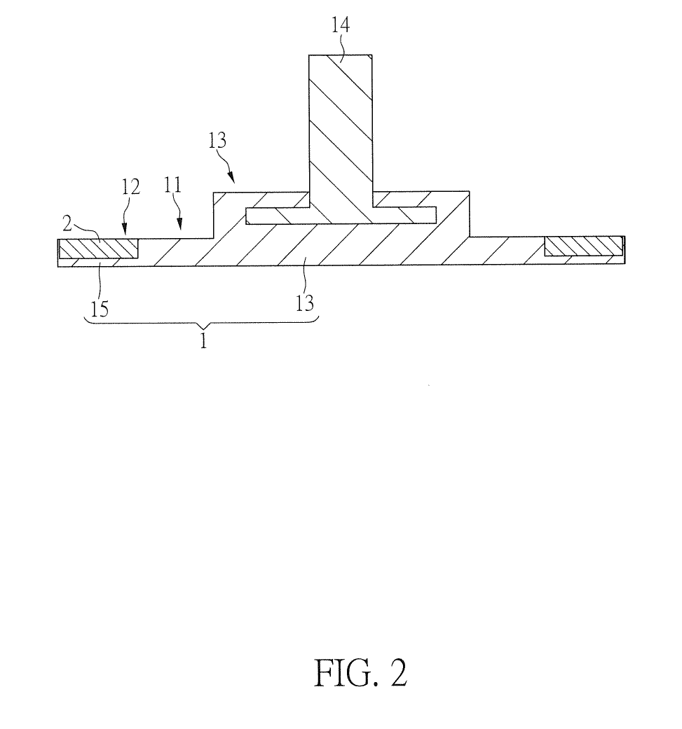

With reference to FIGS. 1 and 2 for a pad of a sucking disc structure of the first preferred embodiment of the present invention, the sucking disc structure comprises a circular disc shaped main body 1 made of a soft material such as rubber, and the main body 1 includes an axial surface 11 provided for a pressing member of a sucking disc to press thereon. The main body 1 includes a circular pressure bearing block 2 integrally formed with the main body 1 and fixed and coupled to the main body 1, and the pressure bearing block 2 is in a uniform hard form such as a circular metal sheet. In this embodiment, the pressure bearing block 2 is fixed onto the axial surface 11 integrally, so that the axial surface 11 defines a circular hard pressed area 12 provided for a pressing member of the sucking disc to press thereon. The main body 1 includes a pressed portion 15 disposed at the bottom of the hard pressed area 12, and the remaining portion is formed as a central portion 13. Wherein, the main body 1 includes a lifting portion 14 disposed at the central portion 13, such that after the pad is assembled to the sucking disc structure, the lifting portion 14 is controlled to operate and produce a deformation of the central portion 13, so that the sucking disc will produce a suction.

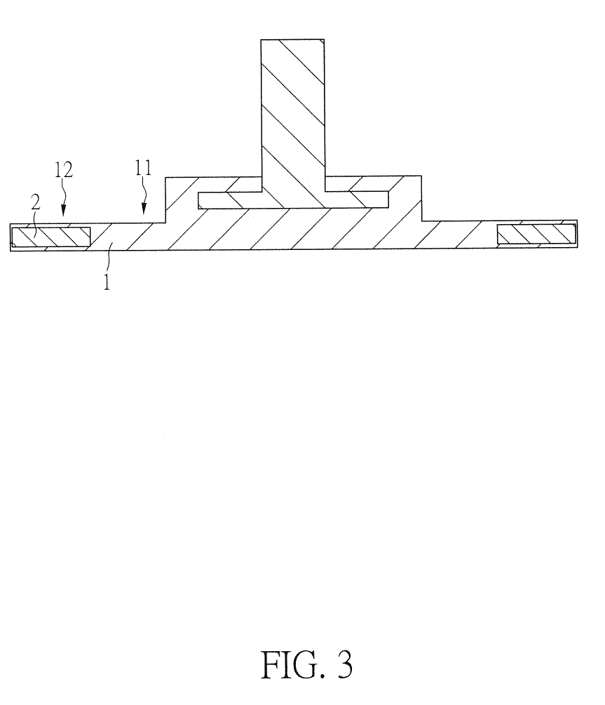

With reference to FIG. 3 for a pad of a sucking disc structure in accordance with the second preferred embodiment of the present invention, the difference between this preferred embodiment and the first preferred embodiment resides on the position of installing the pressure bearing block 2. In FIG. 3, the pressure bearing block 2 is integrally buried into the main body 1. Although the pad still has an appearance of a circular rubber disc, yet the main body 1 has the pressure bearing block 2 buried onto the axial surface 11 to define a circular hard pressed area 12 provided for the pressing member of the sucking disc to press thereon.

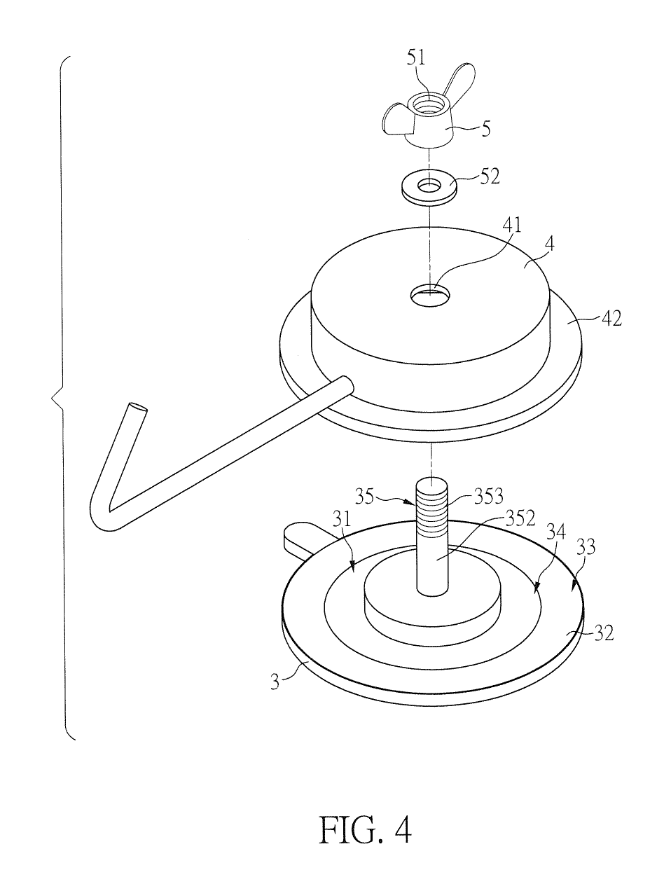

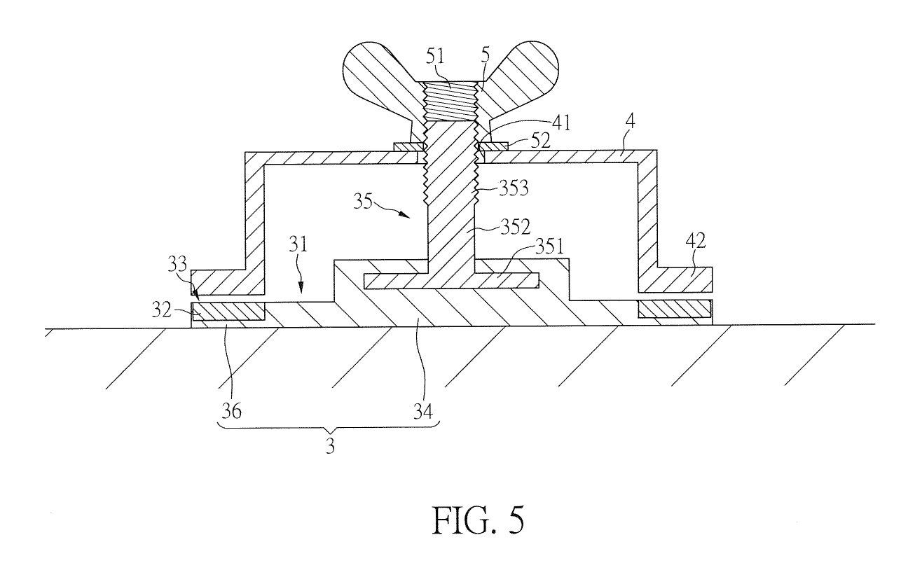

The present invention further provides a sucking disc structure assembled with the aforementioned pad as shown in FIGS. 4 and 5, wherein the sucking disc structure comprises a pad, a pressing member 4 and a control member 5, wherein the pad is a circular disc shaped main body 3 made of a soft material, and the top of the main body 3 is defined as an axial surface 31 provided for the pressing member 4 to press thereon. The main body 3 has a circular pressure bearing block 32 integrated with the main body 3, and the pressure bearing block 32 is in a uniform hard form such as a metal circular sheet. Wherein, the pressure bearing block 32 is installed at a position of the pad as shown in the aforementioned two preferred embodiments and may be integrated with the axial surface 31, or integrally buried into the main body 3. By the aforementioned two methods, the axial surface 31 defines a circular hard pressed area 33. The main body 3 has a pressed portion 36 formed at the bottom of the hard pressed area 33, and the remaining portion is formed as a central portion 34.

The main body 3 has a lifting portion 35 disposed at the central portion 34, wherein the lifting portion 35 has a base 351 buried into the central portion 34, and a column 352 erected from the base 351 and protruded out from the main body 3. The external periphery of the column 352 has a threaded section 353. The pressing member 4 is stacked onto the pad, and the pressing member 4 has a through hole 41 corresponsive to the lifting portion 35 for allowing the column 352 of the lifting portion 35 to pass out from the pressing member 4. The pressing member 4 has a circular pressing portion 42 provided for stacking onto the axial surface 31 of the pad. Further, the pressing portion 42 of the pressing member 4 is stacked onto the hard pressed area 33.

The control member 5 is installed on the pressing member 4 and coupled to the lifting portion 35. In this embodiment, the control member 5 has a penetrating screw hole 51 provided for screwing onto the threaded section 353 of the column 352 of the lifting portion 35. On the other hand, the control member 5 is blocked by the periphery of the through hole 41 of the pressing member 4. Further, a gasket 52 is installed between the control member 5 and the periphery of the through hole 41.

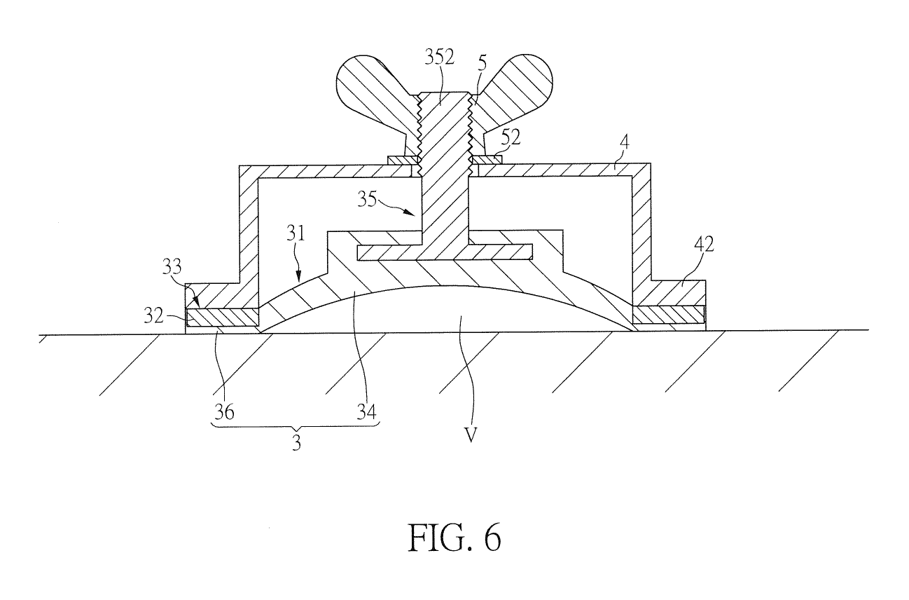

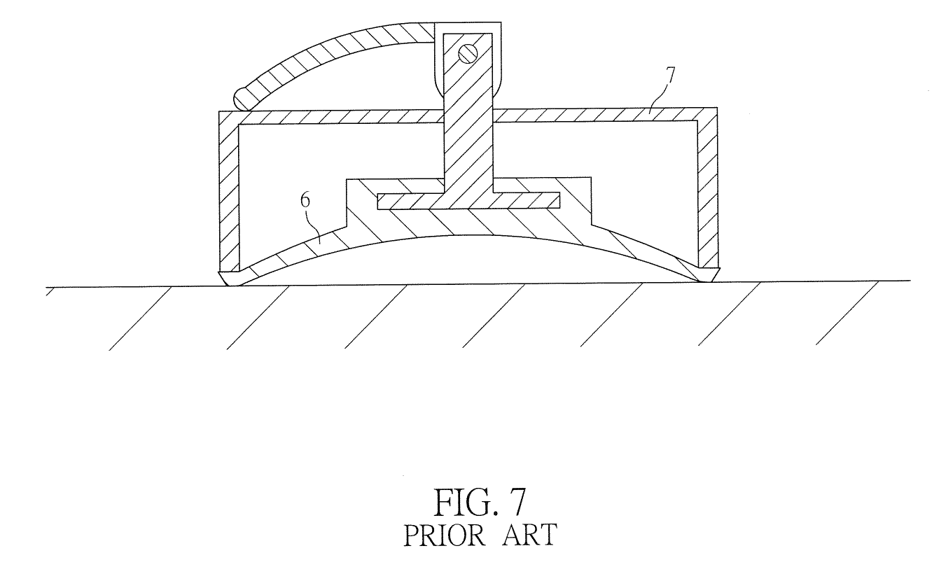

With the aforementioned structure and configuration, the control member 5 is blocked at the through hole 41, such that when the control member 5 is rotated, a downward pressing force is produced as shown in FIG. 6, and such force presses at the pressing member 4 to further press onto the axial surface 31 of the pad. It is noteworthy to point out that the pressing member 4 presses at the hard pressed area 33 of the axial surface 31. Then, the hard pressed area 33 acts this pressing force onto the pressed portion 36 of the main body. As the control member 5 continues to rotate, the control member 5 is blocked at the through hole 41, such that an opposite fixing end is formed, and the lifting portion 35 is pulled by the control member 5 to move upward, and the central portion 34 of the main body 3 is lifted to produce a deformation, so as to produce a vacuum space V which gives a sucking source of the sucking disc.

In summation of the description above, the pressure bearing block 32 is a hard uniform sheet that allows the pressing forces exerted onto the pressure bearing block to be distributed uniformly, so that an equal pressure is received at each position of the hard pressed area 33, and the pressed portion 36 under the main body 3 is pressed by a surface-contact pressing mode, so as to increase the contact area between the pad and the smooth surface. On the other hand, the pressure bearing block 32 is made of a hard material and integrated with the pressed portion 36, so that the deformation of the pressed portion 36 is limited significantly to maintain a large contact area between the pad and the smooth surface. The aforementioned characteristics can maintain a high airtightness of the pad and extend the time of the sucking disc to be attached onto the smooth surface.

1. A pad of a sucking disc structure, comprising:
a main body, made of a first material, the main body having a central portion and an axial surface extending annularly thereabout, the axial surface being configured for pressing engagement by a pressing member of a sucking disc, the central portion defining a central surface raised relative to the axial surface;
a circular pressure bearing block disposed on the main body, the pressure bearing block being fixedly coupled to the axial surface of the main body to remain radially offset from the central surface, and the pressure bearing block being made of a second material greater in hardness than the first material and defining a circular hard pressed area on the axial surface; and
a lifting portion coupled to the central surface disposed in an inner portion of a ring formed by the pressure bearing block on the main body.

2. The pad of a sucking disc structure according to claim 1, wherein the pressure bearing block is disposed on the axial surface.

3. The pad of a sucking disc structure according to claim 1, wherein the pressure bearing block is buried in the main body.

4. A sucking disc structure, comprising:
a pad, a pressing member and a control member, the pad including a main body made of a first material, the main body having a central portion and an axial surface extending annularly thereabout, the axial surface being configured for pressing engagement by the pressing member, the central portion defining a central surface raised relative to the axial surface;
a circular pressure bearing block fixedly coupled to the axial surface of the main body to remain radially offset from the central surface, the pressure bearing block being made of a second material greater in hardness than the first material and defining a circular hard pressed area on the axial surface;
a lifting portion coupled to the central surface disposed in an inner portion of a ring formed by the pressure bearing block;
the pressing member being disposed on the axial surface, the control member being installed on the pressing member to be coupled to the lifting portion; and
the pressing member having a circular pressing portion, the control member controlling the pressing portion to move towards the pad to press onto the hard pressed area by displacing relative to the lifting portion, and thereby produces a deformation in the inner portion of the ring formed by the pressure bearing block.

5. The sucking disc structure according to claim 4, wherein the pressure bearing block is disposed on the axial surface.

6. The sucking disc structure according to claim 4, wherein the pressure bearing block is buried in the main body.

7. The sucking disc structure according to claim 4, wherein the pressing member includes a through hole, the lifting portion extending from the main body and passed through the through hole, a threaded section being disposed around the lifting portion; the control member being blocked by the pressing member, and the control member including a screw hole engaging the threaded section of the lifting portion, the control member thereby being rotated to control operation of the pressing member and the lifting portion.
